(19) United States
(12) Patent Application Publication
(10) Pub. No.: US 2026/0322779 A1
(43) Pub. Date: Oct. 15, 2026

(54) ENABLING REAL-TIME COMMUNICATION BETWEEN AN INITIATING USER AND A RECIPIENT USER

(71) Applicant: Telefonaktiebolaget LM Ericsson (publ), Stockholm (SE)

(72) Inventors: Peter ÖKVIST, LULEÅ (SE); Tommy ARNGREN, SÖDRA SUNDERBYN (SE); Niklas JALDÉN, ENKÖPING (SE)

(73) Assignee: Telefonaktiebolaget LM Ericsson (publ), Stockholm (SE)

(21) Appl. No.: 19/483,539

(22) PCT Filed: May 16, 2023
(86) PCT No.: PCT/EP2023/063150

§ 371 Date: Nov. 11, 2025

(51) Int. Cl. H04L 51/52; H04L 51/10

(52) U.S. Cl. CPC H04L 51/52; H04L 51/10

(57) ABSTRACT

It is provided a method for enabling real-time communication between an initiating user and a recipient user. The method is performed by a communication enabler. The method comprises: obtaining audio data, reflecting voice audio from the initiating user; determining, based on the audio data, that the initiating user desires to communicate with the recipient user; determining that there is a social connection between the initiating user and the recipient user; determining that the initiating user and the recipient user are near each other; and enabling real-time communication between the initiating user and the recipient user.

### TECHNICAL FIELD

The present disclosure relates to the field of enabling real-time communication between an initiating user and a recipient user, based on proximity and a social connection between the users.

### BACKGROUND

Noise cancelling headphones are increasing in popularity, to remove or reduce external sound for some local peace and quiet or to enjoy a selected sound source. Some headphones give the user the possibility to turn off noise cancellation to allow for conversation without removing headphones.

For this to work, the user needs to have observed the person that wants to speak with the user, but identifying this is more difficult due to the noise cancellation. Another challenge is when the distance between the user and the person that wants to speak with the user, where visual identification can be possible but it is too far to alert the user by voice.

Another way to set up communication is a smartphone using a cellular network. The initiating user can e.g. initiate a voice call in the smartphone by triggering a digital assistant, such as Google Assistant or Apple Siri, e.g. by voicing “Call Charlie”, or navigating to the intended recipient of the voice call through an address book in the smartphone.

However, the solutions to enable communication today are general and are not context aware.

### SUMMARY

One object is to improve how real-time communication is enabled based on context of the initiating user and the recipient user.

According to a first aspect, it is provided a method for enabling real-time communication between an initiating user and a recipient user. The method is performed by a communication enabler. The method comprises: obtaining audio data, reflecting voice audio from the initiating user; determining, based on the audio data, that the initiating user desires to communicate with the recipient user; determining that there is a social connection between the initiating user and the recipient user; determining that the initiating user and the recipient user are near each other; and enabling real-time communication between the initiating user and the recipient user.

The enabling real-time communication may comprise establishing a real-time communication channel between an initiating user device of the initiating user and a recipient user device of the recipient user.

The enabling real-time communication may comprise modifying a noise suppression function of an audio device of the recipient user, to enable the recipient user to hear speech directly from the initiating user.

The determining that the initiating user and the recipient user are near each other may comprise comparing first location data of an initiating user device of the initiating user with second location data of a recipient user device of the recipient user: In this case, the initiating user and the recipient user are determined to be near each other when a distance between the initiating user device and the recipient user device is less than a threshold distance.

The determining that the initiating user and the recipient user are near each other may comprise determining that an orientation of the initiating user deviates less than a threshold angle from a direction from the initiating user towards the recipient user.

The determining that the initiating user and the recipient user are near each other may comprise finding a sound event that is captured both in audio data from an initiating user device of the initiating user and in audio data from a recipient user device of the recipient user.

The determining that the initiating user desires to communicate with the recipient user may comprise determining an identifier of the recipient user in the audio data.

The determining that there is a social connection may be based on the identifier of the recipient user.

The determining that the initiating user and the recipient user are near each may result in narrowing down the list to a single recipient user from multiple potential recipient users.

The determining that the initiating user desires to communicate with the recipient user may comprise identifying the initiating user using the voice audio in the audio data.

The determining that there is a social connection may comprise matching an identity of the initiating user against a list users associated with the recipient user.

According to a second aspect, it is provided a communication enabler for enabling real-time communication between an initiating user and a recipient user. The communication enabler comprises: processing circuitry; and a memory storing instructions that, when executed by the processing circuitry, cause the communication enabler to: obtain audio data, reflecting voice audio from the initiating user; determine, based on the audio data, that the initiating user desires to communicate with the recipient user; determine that there is a social connection between the initiating user and the recipient user; determine that the initiating user and the recipient user are near each other; and enable real-time communication between the initiating user and the recipient user.

The instructions to enable real-time communication may comprise instructions that, when executed by the processing circuitry, cause the communication enabler to establish a real-time communication channel between an initiating user device of the initiating user and a recipient user device of the recipient user.

The instructions to enable real-time communication may comprise instructions that, when executed by the processing circuitry, cause the communication enabler to modify a noise suppression function of an audio device of the recipient user, to enable the recipient user to hear speech directly from the initiating user.

The instructions to determine that the initiating user and the recipient user are near each other may comprise instructions that, when executed by the processing circuitry, cause the communication enabler to compare first location data of an initiating user device of the initiating user with second location data of a recipient user device of the recipient user. In this case, the initiating user and the recipient user are determined to be near each other when a distance between the initiating user device and the recipient user device is less than a threshold distance.

The instructions to determine that the initiating user and the recipient user are near each other may comprise instructions that, when executed by the processing circuitry, cause the communication enabler to determine that an orientation of the initiating user deviates less than a threshold angle from a direction from the initiating user towards the recipient user.

The instructions to determine that the initiating user and the recipient user are near each other may comprise instructions that, when executed by the processing circuitry, cause the communication enabler to find a sound event that is captured both in audio data from an initiating user device of the initiating user and in audio data from a recipient user device of the recipient user.

The instructions to determine that the initiating user desires to communicate with the recipient user may comprise instructions that, when executed by the processing circuitry, cause the communication enabler to determine an identifier of the recipient user in the audio data.

The instructions to determine that there is a social connection may comprise instructions that, when executed by the processing circuitry, cause the communication enabler to determine that there is a social connection based on the identifier of the recipient user.

The instructions to determine that the initiating user and the recipient user are near each other may comprise instructions that, when executed by the processing circuitry, cause the communication enabler to narrow down the list to a single recipient user from multiple potential recipient users.

The instructions to determine that the initiating user desires to communicate with the recipient user may comprise instructions that, when executed by the processing circuitry, cause the communication enabler to identify the initiating user using the voice audio in the audio data.

The instructions to determine that there is a social connection may comprise instructions that, when executed by the processing circuitry, cause the communication enabler to match an identity of the initiating user against a list users associated with the recipient user.

According to a third aspect, it is provided a computer program for enabling real-time communication between an initiating user and a recipient user. The computer program comprises computer program code which, when executed on a communication enabler causes the communication enabler to: obtain audio data, reflecting voice audio from the initiating user; determine, based on the audio data, that the initiating user desires to communicate with the recipient user; determine that there is a social connection between the initiating user and the recipient user; determine that the initiating user and the recipient user are near each other; and enable real-time communication between the initiating user and the recipient user.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating relationships between the initiating user and the recipient user of FIG. 1 according to one embodiment;

FIGS. 3A-G are schematic diagrams illustrating embodiments of where embodiments of a communication enabler can be implemented;

FIG. 4 is a flow chart illustrating embodiments of methods for enabling real-time communication between an initiating user and a recipient user;

FIG. 5 is a schematic diagram illustrating components of the communication enabler of FIGS. 3A-G according to one embodiment;

FIG. 6 is a schematic diagram showing functional modules of the communication enabler of FIGS. 3A-G according to one embodiment; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, a communication enabler provides a simplified way to enable real-time communication between an initiating user and a recipient user. The initiating user (initiating the communication) and the recipient user (being the target of the communication from the initiating user) are in proximity with each other and have a social connection. The communication is enabled based on voice communication from the initiating user. The filtering of potential recipients based on proximity and social connection is applied to allow the communication to be enabled even when the initiating user is not very specific in the voice utterance. For instance, it may be sufficient for the initiating user to voice the first name of the recipient user, even though the contact list of the initiating user may have many contacts having the same first name.

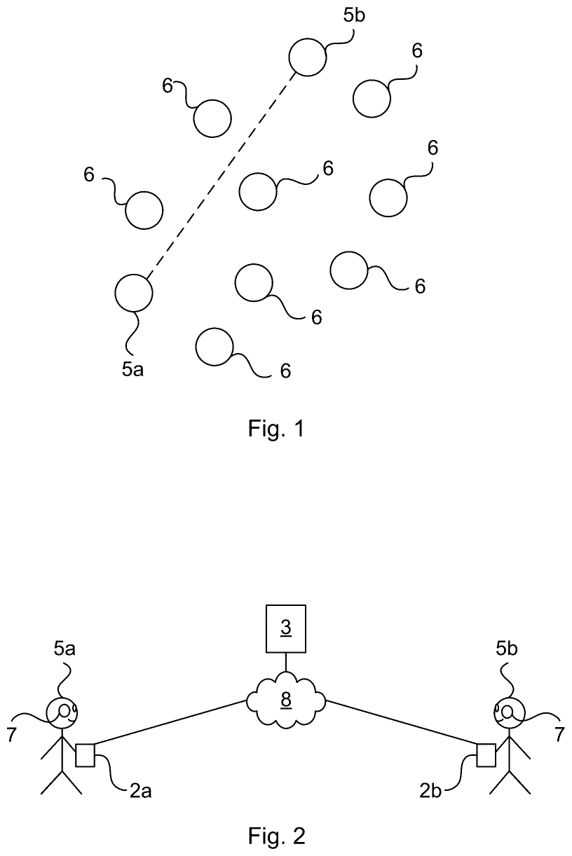

FIG. 1 is a schematic diagram illustrating an environment in which embodiments presented herein can be applied. An initiating user 5a is in an environment with people around, including a recipient user 5b and (for the purpose of communication from the initiating user 5a) irrelevant people 6. The environment can e.g. be a train station, a public square, an entertainment venue, a shopping centre, or anywhere else where it is possible for the initiating user 5a to stumble upon a person that they know from before, i.e. that the initiating user 5a has a social connection to.

In this environment, the initiating user 5a visually spots the recipient user 5b (“Charlie” in this example), and intends to initiate communication with the recipient user 5b. The initiating user 5a uses his/her voice to express this intent, e.g. by mentioning “Hey Charlie!” According to embodiments presented herein, a communication enabler 1 acts upon this voiced intent to enable communication between the initiating user 5a and the recipient user 5b. The initiating user is the person that initiates the communication, and the recipient user is the person that is the target of the communication from the initiating user.

FIG. 2 is a schematic diagram illustrating relationships between the initiating user 5a and the recipient user 5b of FIG. 1 according to one embodiment.

The initiating user 5a carries an initiating user device 2a and optionally headphones 7. The recipient user 5b carries a recipient user device 2b and optionally headphones 7. Optionally, either one or both of the initiating user device 2a and the recipient user device 2b are connected to a communication network 8. Either one or both pairs of headphones 7 can include noise cancellation capability.

The communication between the initiating user device 2a and/or the recipient user device 2b and the communication network 8 can occur over any suitable wireless interface, e.g. any one or more of Bluetooth or Bluetooth Low Energy (BLE), ZigBee, any of the IEEE 802.11x standards (also known as Wi-Fi), a cellular network specification, etc.

The communication network 8 can be a wide area network 6, such as the Internet, e.g. via Wi-Fi or a cellular network, to allow communication between the initiating user device 2a/the recipient user device 2b and a server 3. The communication network 8 can also provide capability of communication between the initiating user device 2a and the recipient user device 2b.

When the communication network 8 comprises a cellular network, the cellular network can e.g. comply with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network.

In one embodiment, the server is used to store data about users in the system, such as the initiating user 5a and the recipient user 5b. Specifically, the information about the users can include social connections between users, e.g. based on social platform connections, text messaging between users, voice calls between users, e-mail conversation between users, contact list entries of users, person identification in media objects (e.g. photos, videos), etc.

The server can also store data about the position of the user devices 2a, 2b, and thus implicitly the users 5a, 5b of the system. The position can be based on satellite-based positioning (e.g. GNSS (global navigation satellite systems) such as GPS (global positioning system), Galileo, etc.), radio beacon-based positioning, device tracking (e.g. Apple AirTag, Tile), cellular network positioning (such as 5G system location services), radio environment fingerprinting, Wi-Fi positioning, ultra-wideband (UWB) positioning, etc.

The server can also store data about device capabilities, such as noise suppression, microphone, speech/voice recognition, further audio/voice processing capabilities such as ASR (automatic speech recognition), NLP (natural language processing), NLU (natural language understanding), etc.

The server can also store data about other parts of user context, such as user at work doing tasks A, at home occupied with tasks B, not at home but at office hours, at home at non-office hours, etc.

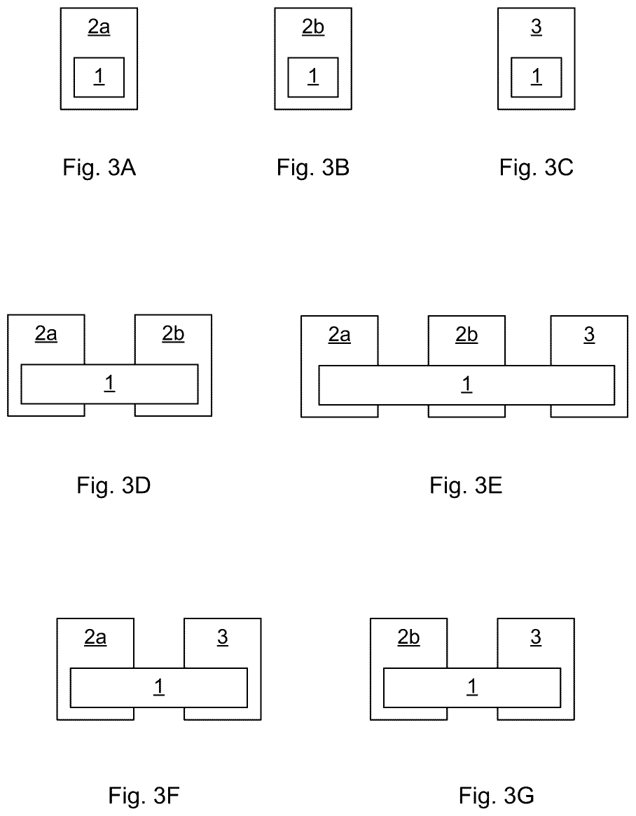

FIGS. 3A-G are schematic diagrams illustrating embodiments of where embodiments of a communication enabler 1 can be implemented. It is to be noted that the communication enabler 1 can be implemented in any suitable node, including, but not limited to, the embodiments shown in FIGS. 3A-G and explained below.

In FIG. 3A, the communication enabler 1 is shown implemented in the initiating user device 2a. The initiating user device 2a is thus the host device for the communication enabler 1 in this implementation.

In FIG. 3B, the communication enabler 1 is shown implemented in the recipient user device 2b. The recipient user device 2b is thus the host device for the communication enabler 1 in this implementation.

In FIG. 3C, the communication enabler 1 is shown implemented in the server 3. The server 3 is thus the host device for the communication enabler 1 in this implementation.

In FIG. 3D, the communication enabler 1 is shown implemented partly in the initiating user device 2a and partly in the recipient user device 2b. Both the initiating user device 2a and the recipient user device 2b act (at least partly) as host devices for the communication enabler 1 in this implementation.

In FIG. 3E, the communication enabler 1 is shown implemented partly in the initiating user device 2a, partly in the recipient user device 2b and partly in the server 3. All of the initiating user device 2a, the recipient user device 2b and the server 3 act (at least partly) as host devices for the communication enabler 1 in this implementation.

In FIG. 3F, the communication enabler 1 is shown implemented partly in the initiating user device 2a and partly in the server 3. Both the initiating user device 2a and the server 3 act (at least partly) as host devices for the communication enabler 1 in this implementation.

In FIG. 3G, the communication enabler 1 is shown implemented partly in the recipient user device 2b and partly in the server 3. Both the recipient user device 2b and the server 3 act (at least partly) as host devices for the communication enabler 1 in this implementation.

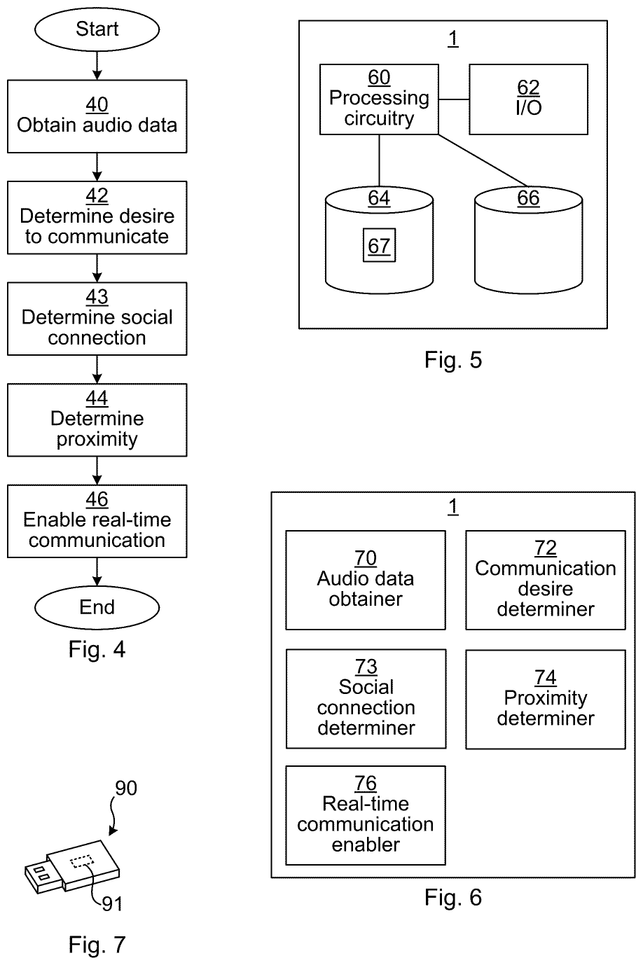

FIG. 4 is a flow chart illustrating embodiments of methods for enabling real-time communication between an initiating user 5a and a recipient user 5b. The method is performed by a communication enabler 1.

In an obtain audio data step 40, the communication enabler 1 obtains audio data, reflecting voice audio from the initiating user 5a. The audio data can be obtained from a microphone on the initiating user device 2a, the recipient user device 2b or headphones 7 connected to a user device.

In a determine desire to communicate step 42, the communication enabler 1 determines, based on the audio data, that the initiating user 5a desires to communicate with the recipient user 5b. This is based on speech or voice recognition, optionally combined with NLP (natural language processing), which can include NLU (natural language understanding). Optionally, this step is based on exploiting another device for the processing of the audio data, e.g. if the communication enabler 1 is implemented in a user device, the audio data can be processed by a server 3.

In one embodiment, the determining that the initiating user 5a desires to communicate with the recipient user 5b comprises determining an identifier of the recipient user in the audio data. The identifier can e.g. be a name of the recipient user.

In one embodiment, the determining that the initiating user 5a desires to communicate with the recipient user 5b comprises identifying the initiating user 5a using the voice audio in the audio data.

Regardless of when the communication enabler 1 is implemented in the initiating user device 2a or the recipient user device 2b, this includes determining that the captured voice expressed intent to determine communicate with the recipient user 5b.

When the communication enabler 1 is implemented in the recipient user device 2b, the voice data can be used to determine an identity of the recipient user 5b, e.g. by comparing the voice characteristics with previously stored voice samples for users having a social connection with the recipient user 5b.

Optionally, the audio data is stored for later playback to the recipient user 5b as part of notifying the recipient user of the intent of the initiating user to communicate.

In a determine social connection step 43, the communication enabler 1 determines that there is a social connection between the initiating user 5a and the recipient user 5b.

In one embodiment, the determining that there is a social connection is based on the identifier of the recipient user 5b, as well as an identifier of the initiating user 5a.

In one embodiment, the determining that there is a social connection comprises matching an identity of the initiating user 5a against a list of users associated with the recipient user 5b. Optionally, the social connection can be based on a multi-hop connection. In other words, the initiating user 5a may have a social connection with an intermediate social connection. The intermediate social connection, in turn, has a social connection with the recipient user.

In a determine proximity step 44, the communication enabler 1 determines that the initiating user 5a and the recipient user 5b are near each other.

Near can be defined in various ways. One way is to define near as being within plausible eyesight. More specific examples of how near can be determined follows now.

In one embodiment, the determining that the initiating user 5a and the recipient user 5b are near each other comprises comparing first location data of an initiating user device 2a of the initiating user 5a with second location data of a recipient user device 2b of the recipient user 5b. In this case, the initiating user 5a and the recipient user 5b are determined to be near each other when a distance between the initiating user device 2a and the recipient user device 2b is less than a threshold distance. In other words, the initiating user 5a and the recipient user 5b are determined to be near each other when the distance between them is less than a threshold distance. The threshold distance can be set to a distance within which the initiating user can reasonably visually recognise the recipient user. For instance, the threshold distance can be set to 100 metres, 50 metres, 20 metres, etc. Furthermore, the threshold distance can be set to a distance that is greater than a distance within which the initiating user can touch the recipient user. For instance, the threshold distance could be greater than a meter or two. Hence, in one embodiment, the threshold distance is within the range of one to 100 metres. In one embodiment, the threshold distance is within the range of two to 50 metres.

In one embodiment, the determining that the initiating user 5a and the recipient user 5b are near each other comprises determining that an orientation of the initiating user 5a deviates less than a threshold angle from a direction from the initiating user 5a towards the recipient user 5b. This can be combined with the distance condition. For instance, near can in this case imply that the orientation of the initiating user 5a is within x degrees of the direction to the recipient user 5b, and optionally that the distance between the initiating user 5a and the recipient user 5b is less than y metres.

In one embodiment, the determining that the initiating user 5a and the recipient user 5b are near each other comprises finding a sound event that is captured both in audio data from the initiating user device 2a of the initiating user 5a and in audio data from the recipient user device 2b of the recipient user 5b. Alternatively or additionally, the determining that the initiating user 5a and the recipient user 5b are near each other comprises finding (common) visual characteristics that is captured both in video data from the initiating user device 2a of the initiating user 5a and in video data from the recipient user device 2b of the recipient user 5b. The common visual characteristics can e.g. be a certain (sufficiently unique) light pattern, e.g. flickering or 2D pattern, from streetlights, stars (varies based on cloud pattern), city skyline at low-light hours, or a unique background such as a known venue, Mona Lisa, Eiffel tower, Big Ben, etc. street sign, etc.

Alternatively or additionally, the determining that the initiating user 5a and the recipient user 5b are near each other comprises determining that a radio environment fingerprint is sufficiently similar. The radio environment fingerprint can e.g. be based on Wi-Fi signals, UWB signals and/or cellular network signals.

In one embodiment, the determining that the initiating user 5a and the recipient user 5b are near each other comprises narrowing down the list to a single recipient user from multiple potential recipient users.

In an enable real-time communication step 46, the communication enabler 1 enables real-time communication between the initiating user 5a and the recipient user 5b. This is performed after determining both the social connection and determining proximity.

In one embodiment, the determining that the initiating user 5a and the recipient user 5b are near each other comprises narrowing down the list to a single recipient user from multiple potential recipient users. This can be based on the following procedure. Based on the audio data, a set of multiple potential recipient users is determined. For instance, continuing on the example above, there may be multiple recipient users with a social connection to the initiating user that have the name “Charlie”. The recipient user can then be determined to be the one (of the potential recipient users) that is within range (less than the threshold distance) of the initiating user 5a. If there are multiple potential recipient users within range, the one that is closest can be selected. Other criteria can optionally also be used for the selection of the recipient user from the set of potential recipient users. One criteria can be whether the potential recipient user is a private connection (optionally detailed to family or non-family private connection) or business connection. Alternatively or additionally, the selection is based on time-or day (e.g. office hours or not). Alternatively or additionally, the selection is based on the location, e.g. office, near the home, etc.

In one embodiment, the enabling real-time communication comprises establishing a real-time communication channel between the initiating user device 2a of the initiating user 5a and a recipient user device 2b of the recipient user 5b.

This can result in the recipient user device 2b pausing a media stream and/or deactivate noise cancellation.

In one embodiment, the enabling real-time communication comprises modifying a noise suppression function of an audio device of the recipient user 5b, to enable the recipient user 5b to hear speech directly from the initiating user 5a.

Using embodiments presented herein, communication is enabled between the initiating user 5a and a recipient user 5b in an intuitive and simple manner. Moreover, since filtering of potential recipient user 5b is performed based on location and social connection, the number of potential recipient users is significantly reduced. This allows the voice command to be quite ambiguous, e.g. only using a first name or even no-name at all, to set up the communication. The initiating user 5a thereby does not need to remember e.g. the full name (which may be in the initiating user's contact list) of a person that is spotted and the recipient user can still be conclusively determined. This enables more spontaneous and simple way to communicate.

FIG. 5 is a schematic diagram illustrating components of the communication enabler 1 of FIGS. 3A-G according to one embodiment. It is to be noted that when the communication enabler 1 is implemented in a host device (see FIGS. 3A-G), one or more of the mentioned components can be shared with the host device. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processing circuitry 60 could alternatively be implemented using an application specific integrated circuit (ASIC), field programmable gate array (FPGA), etc. The processing circuitry 60 can be configured to execute the method described with reference to FIG. 4 above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

An I/O interface 62 is provided for communicating with external and/or internal entities using wired communication, e.g. based on Ethernet, and/or wireless communication, e.g. Wi-Fi, Bluetooth, Bluetooth Low Energy, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the communication enabler 1 are omitted in order not to obscure the concepts presented herein.

FIG. 6 is a schematic diagram showing functional modules of the communication enabler 1 of FIGS. 3A-G according to one embodiment. The modules are implemented using software instructions such as a computer program executing in the communication enabler 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIG. 4.

An audio data obtainer 70 corresponds to step 40. A communication desire determiner corresponds to step 42. A social connection determiner 73 corresponds to step 43. A proximity determiner 74 corresponds to step 44. A real-time communication enabler 76 corresponds to step 46.

FIG. 7 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g. a Universal Serial Bus (USB) drive. As explained above, the computer program product could also be embodied in a memory of a device, such as the computer program product 64 of FIG. 5. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for enabling real-time communication between an initiating user and a recipient user, the method being performed by a communication enabler, the method comprising:
obtaining audio data, reflecting voice audio from the initiating user;
determining, based on the audio data, that the initiating user desires to communicate with the recipient user;
determining that there is a social connection between the initiating user and the recipient user;
determining that the initiating user and the recipient user are near each other; and
enabling real-time communication between the initiating user and the recipient user.

2. The method according to claim 1, wherein the enabling real-time communication comprises establishing a real-time communication channel between an initiating user device of the initiating user and a recipient user device of the recipient user.

3. The method according to claim 1, wherein the enabling real-time communication comprises modifying a noise suppression function of an audio device of the recipient user, to enable the recipient user to hear speech directly from the initiating user.

4. The method according to claim 1, wherein the determining that the initiating user and the recipient user are near each other comprises comparing first location data of an initiating user device of the initiating user with second location data of a recipient user device of the recipient user, and wherein the initiating user and the recipient user are determined to be near each other when a distance between the initiating user device and the recipient user device is less than a threshold distance.

5. The method according to claim 4, wherein the determining that the initiating user and the recipient user are near each other comprises determining that an orientation of the initiating user deviates less than a threshold angle from a direction from the initiating user towards the recipient user.

6. The method according to claim 1, wherein the determining that the initiating user and the recipient user are near each other comprises finding a sound event that is captured both in audio data from an initiating user device of the initiating user and in audio data from a recipient user device of the recipient user.

7. The method according to claim 1, wherein the determining that the initiating user desires to communicate with the recipient user comprises determining an identifier of the recipient user in the audio data.

8. The method according to claim 7, wherein the determining that there is a social connection is based on the identifier of the recipient user.

9. The method according to claim 8, wherein the determining that the initiating user and the recipient user are near each other results in narrowing down the list to a single recipient user from multiple potential recipient users.

10. The method according to claim 1, wherein the determining that the initiating user desires to communicate with the recipient user comprises identifying the initiating user using the voice audio in the audio data.

11. The method according to claim 10, wherein the determining that the initiating user desires to communicate with the recipient user comprises determining an identifier of the recipient user in the audio data, wherein the determining that there is a social connection comprises matching an identity of the initiating user against a list users associated with the recipient user.

12. A communication enabler for enabling real-time communication between an initiating user and a recipient user, the communication enabler comprising:
processing circuitry; and
a memory storing instructions that, when executed by the processing circuitry, cause the communication enabler to:
obtain audio data, reflecting voice audio from the initiating user;
determine, based on the audio data, that the initiating user desires to communicate with the recipient user;
determine that there is a social connection between the initiating user and the recipient user;
determine that the initiating user and the recipient user are near each other; and
enable real-time communication between the initiating user and the recipient user.

13. The communication enabler according to claim 12, wherein the instructions to enable real-time communication comprise instructions that, when executed by the processing circuitry, cause the communication enabler to establish a real-time communication channel between an initiating user device of the initiating user and a recipient user device of the recipient user.

14. The communication enabler according to claim 12, wherein the instructions to enable real-time communication comprise instructions that, when executed by the processing circuitry, cause the communication enabler to modify a noise suppression function of an audio device of the recipient user, to enable the recipient user to hear speech directly from the initiating user.

15. The communication enabler according to claim 12, wherein the instructions to determine that the initiating user and the recipient user are near each other comprise instructions that, when executed by the processing circuitry, cause the communication enabler to compare first location data of an initiating user device of the initiating user with second location data of a recipient user device of the recipient user, and wherein the initiating user and the recipient user are determined to be near each other when a distance between the initiating user device and the recipient user device is less than a threshold distance.

16. The communication enabler according to claim 15, wherein the instructions to determine that the initiating user and the recipient user are near each other comprise instructions that, when executed by the processing circuitry, cause the communication enabler to determine that an orientation of the initiating user deviates less than a threshold angle from a direction from the initiating user towards the recipient user.

17. The communication enabler according to claim 12, wherein the instructions to determine that the initiating user and the recipient user are near each other comprise instructions that, when executed by the processing circuitry, cause the communication enabler to find a sound event that is captured both in audio data from an initiating user device of the initiating user and in audio data from a recipient user device of the recipient user.

18. The communication enabler according to claim 12, wherein the instructions to determine that the initiating user desires to communicate with the recipient user comprise instructions that, when executed by the processing circuitry, cause the communication enabler to determine an identifier of the recipient user in the audio data.

19. The communication enabler according to claim 18, wherein the instructions to determine that there is a social connection comprise instructions that, when executed by the processing circuitry, cause the communication enabler to determine that there is a social connection based on the identifier of the recipient user.

20. The communication enabler according to claim 19, wherein the instructions to determine that the initiating user and the recipient user are near each other comprise instructions that, when executed by the processing circuitry, cause the communication enabler to narrow down the list to a single recipient user from multiple potential recipient users.

21. The communication enabler according to claim 12, wherein the instructions to determine that the initiating user desires to communicate with the recipient user comprise instructions that, when executed by the processing circuitry, cause the communication enabler to identify the initiating user using the voice audio in the audio data.

22. The communication enabler according to claim 21, wherein the instructions to determine that the initiating user desires to communicate with the recipient user comprise instructions that, when executed by the processing circuitry, cause the communication enabler to determine an identifier of the recipient user in the audio data, and wherein the instructions to determine that there is a social connection comprise instructions that, when executed by the processing circuitry, cause the communication enabler to match an identity of the initiating user against a list users associated with the recipient user.

23-24. (canceled)
